(19) United States
(12) Patent Application Publication
(10) Pub. No.: US 2013/0062872 A1
(43) Pub. Date: Mar. 14, 2013

(54) Method for Pairing Food Recipes with Wine

(71) Applicant: Eugene Anthony Sheridan, Palos Verdes, CA (US)

(72) Inventor: Eugene Anthony Sheridan, Palos Verdes, CA (US)

(21) Appl. No.: 13/597,702

(22) Filed: Aug. 29, 2012

Related U.S. Application Data
(60) Provisional application No. 61/528,530, filed on Aug. 29, 2011.

(51) Int. Cl. B42D 15/00

(52) U.S. Cl. 283/67

(57) ABSTRACT

It is a common problem for the typical consumer that is not highly educated or experienced in pairing wine with food, to determine what food recipe would be best suited to combine with a given bottle of wine. This invention offers the consumer a significant reduction in effort, time and risk by providing a food recipe affixed to the wine bottle. The food recipe affixed to the bottle has been selected based on its complimentary flavor and aroma to the wine, creating an attractive pairing of food and wine for the consumer. When selecting the bottle of wine, the consumer has an immediate recommendation for a food recipe to pair with the wine without requiring the consumer to further research such recommendations, thereby saving the consumer time and effort, while reducing their risk in making poor pairing decisions.

This non-provisional utility patent application claims the earlier filing date benefit of the prior co-pending provisional patent application No. 61/528,530 filed Aug. 29, 2011.

### BACKGROUND OF THE INVENTION

It is a common problem for the typical consumer that is not highly educated or experienced in pairing wine with food, to determine what food recipe would be best suited to combine with a given bottle of wine. Many books, magazines, television or radio shows attempt to make this easier for the consumer but most require the consumer to seek out these materials for self-education and many consumers are not prepared to make this additional effort. This new method for pairing food recipes with wine removes this additional effort and offers a novel approach for pairing food recipes with wine.

### BRIEF SUMMARY OF THE INVENTION

This invention offers the consumer a significant reduction in effort, time and risk by providing a food recipe affixed to the wine bottle. The food recipe affixed to the bottle has been selected based on its complimentary flavor and aroma to the wine, creating an attractive pairing of food and wine for the consumer. When selecting the bottle of wine, the consumer has an immediate recommendation for a food recipe to pair with the wine without requiring the consumer to further research such recommendations, thereby saving the consumer time and effort, while reducing their risk in making poor pairing decisions.

### BRIEF DESCRIPTION OF THE DRAWINGS

FIG. 1 is a flow chart illustrating a conceptual process according to an exemplary embodiment of the invention. Each element of the flow chart describes the steps involved in an exemplary embodiment of the invention. Element 1 reflects the selection of a food recipe that matches or compliments well the flavor or aroma of the wine, thereby creating an attractive wine and food pairing for the typical consumer. Element 2 describes the process whereby the food recipe and/or recipe ingredient list is affixed to the wine bottle (through various methods), which may also include additional related information to assist the consumer in creation of their meal or entertainment event. Element 3 describes the consumer decision and action to purchase the wine bottle with food recipe or related information affixed to that bottle. Element 4 describes the consumer action to purchase the needed recipe ingredients, to prepare the recommended food recipe and consume the wine and meal (created from the food recipe) together, thereby reducing time, effort and risk in creation of their meal or entertainment event

FIG. 2 is a conceptual front view of a wine bottle illustrating potential various locations on the bottle that wine labels may be affixed according to an exemplary embodiment of the invention. Element 1 describes the wine label which includes the associated food recipe and/or recipe ingredient list (eg, shipping list), which may also include related information and recommendations to assist the consumer in preparing their associated meal or entertainment event. Such information may also be contained in an electronic format, such as a barcode, as shown in Element 1. Element 2 and 3 show the possible locations to affix the wine label from Element 1 on to the wine bottle including, but not limited to, the base of the wine bottle or the neck of the wine bottle. The adhesive methods, as shown in Element 2 or 3, may be a permanent type or removable type.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

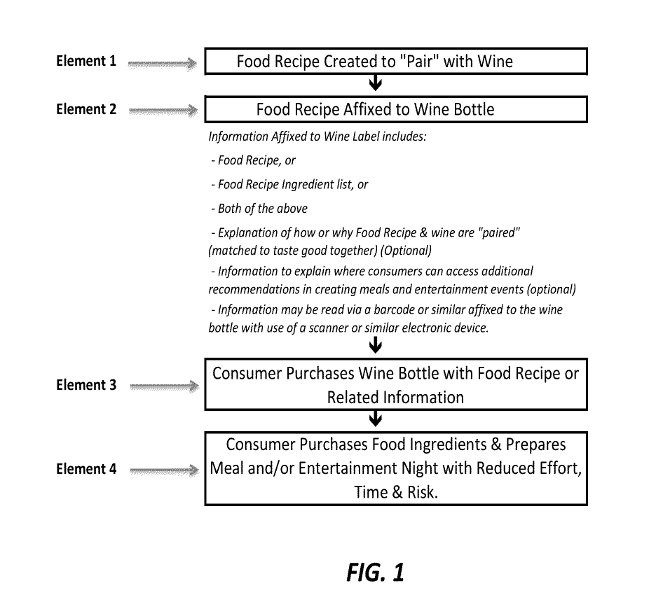

Broadly, an embodiment of the present invention generally provides a process for associating food recipes with wines. As shown in FIG. 1, the process may use a food recipe created to pair with a wine, the food recipe and other information may be affixed to a wine bottle. The food recipe may include a recipe ingredient list, an explanation of how and/or why the particular recipe is paired with the particular wine, and/or other sources where a consumer may access additional information and/or recommendations about creating meals and/or associated entertainment. The process may allow a consumer purchasing a wine bottle paired with a food recipe and/or related information to simultaneously purchase particular ingredients which may allow them to prepare a meal and/or entertainment with reduced effort, time and/or risk.

The process may utilize a variety of various food recipes. The food recipes may be associated with various types of wine. A set of one or more food recipes may be associated with a type of wine. Similarly, a menu of food recipes may be associated with a type of wine. The food recipes may include an explanation and/or instructions of how to prepare the food, a list of ingredients necessary to prepare the food, a list of optional ingredients, and/or any other appropriate information.

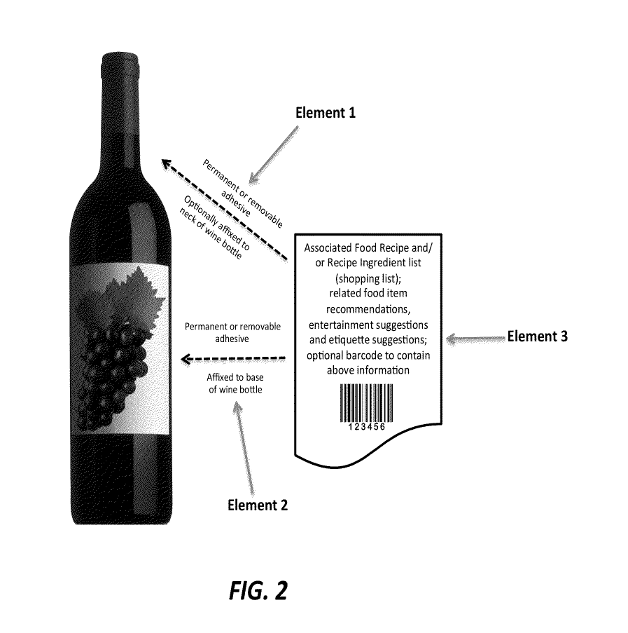

As shown in FIG. 2, the process may use wine labels affixed to wine bottles. The wine labels may be permanent or removable and may be affixed by glue, adhesive, and/or any other appropriate material. The labels may be attached to the neck and/or other appropriate location(s) of the wine bottle. The wine labels may include a variety of printed information relating to the process. One or more food recipes may be printed on each wine label and each label, in turn, may be affixed to a wine bottle. The food ingredients for each recipe may be included on each wine label. Each wine label may provide a menu of various food recipes that pair well with the wine in the bottle to which the label is affixed. Each wine label may provide an explanation of how the food recipe(s) match the wine (i.e., how the flavor of the wine and the food(s) go together well). The food recipes, ingredients or related information and recommendations may be electronically stored on the wine label with a barcode or similar method which can be read electronically with the use of a barcode scanner or similar electronic device.

The process may provide additional information (e.g., how to create an entire meal, entertainment suggestions, etiquette tips, etc.), which may be printed on a particular wine label. The process may provide information about food preparations other than the main course that pair well with a particular wine, which may include food recipes, instructions, and/or recommendations for side dishes, appetizers, desserts, etc. The process may provide information and/or recommendations about entertainment associated with a particular meal, which may include particular music, floral arrangements, games, etc. The process may provide information and/or recommendations about etiquette, which may include proper table setting arrangements, behavioral etiquette tips, entertainment etiquette tips, etc. The process may provide information about how to arrange a meal, make a meal ascetically pleasing, etc. The process may provide information printed on a wine label about how and/or where to access additional information (e.g., website, mobile device application, printed materials, etc.). Such above mentioned information related to recommendations for food preparation, entertainment or etiquette may be electronically stored on the wine label with a barcode or similar method which can be read electronically with the use of a barcode scanner or similar electronic device.

Although the invention has been described above with reference to particular details (e.g., a process having information printed on a wine label and affixed to a wine bottle), one of ordinary skill in the art will recognize that the invention may be performed in different ways without departing from the spirit of the invention (e.g., including a process wherein information may be electronically stored and/or read from a wine label affixed to a wine bottle).

It should be understood, of course, that the foregoing relates to exemplary embodiments of the invention and that modifications may be made without departing from the spirit and scope of the invention as set forth in the following claims.

What is claimed is:

1. A method that is adapted to associate food recipes with wine, the method comprising:
generating one or more food recipes that correspond to one or more wines;
associating each food recipe to a wine; and
printing the food recipe(s) on a wine label and affixing the wine label to a wine bottle holding a wine associated with each food recipe in the set.

2. The method of claim 1, wherein the information printed on the wine label is the food ingredients or shopping list for the food recipe that is associated with that wine.

3. The method of claim 1, wherein the information printed on the wine label is a description of how the food recipe and wine are associated with each other.

4. The method of claim 1 further comprising information printed on the label on how additional recommendations regarding food preparation, related food items (side dishes, appetizers, desserts, etc), entertainment suggestions or etiquette suggestions can be accessed from another source, such as web site, mobile application, or other source.

5. The method of claim 1, wherein the printed information on the label is recorded electronically, via a barcode or similar method, and which can be read by a scanner or similar electronic device.

6. The method of claim 1, wherein the information on the wine label is affixed to the wine bottle through various methods including permanent or removable adhesive, glue or other methods.

7. The method of claim 1, wherein the wine label is affixed to the base of wine bottle or attached to the neck of the wine bottle.
